(19) United States
(12) Patent Application Publication
(10) Pub. No.: US 2009/0129315 A1
(43) Pub. Date: May 21, 2009

(54) DATA DISCARD FOR RADIO LINK CONTROL IN WIRELESS NETWORKS

(75) Inventor: Arnaud Meylan, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/178,015

(22) Filed: Jul. 23, 2008

Related U.S. Application Data
(60) Provisional application No. 60/989,529, filed on Nov. 21, 2007.

(51) Int. Cl. H04Q 7/00

(52) U.S. Cl. 370/328

(57) ABSTRACT

Systems and methodologies are described that facilitate in-band notification of stale service data units (SDU) in a radio link control (RLC) layer for wireless communications. In particular, where SDUs become stale during protocol data unit (PDU) retransmission, in-band notifications can be packed in retransmit PDUs for receipt and interpretation by a receiver. The in-band notification can be a special length indicator that specifies discard of an SDU that was previously partially received, and the transmitter of the PDU can save payload by not retransmitting the stale SDU. In this regard, additional channels, mediums, and/or other out-of-band notifications are not required to specify discard.

### CROSS-REFERENCE TO RELATED APPLICATIONS

This application claims the benefit of U.S. Provisional Patent application Ser. No. 60/989,529 entitled “APPARATUS AND METHOD FOR DATA DISCARD IN LONG TERM EVOLUTION RADIO LINK CONTROL” which was filed Nov. 21, 2007. The entirety of the aforementioned application is herein incorporated by reference.

### BACKGROUND

I. Field

The following description relates generally to wireless communications, and more particularly to discarding data at a radio link layer in wireless communication networks.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

MIMO systems commonly employ multiple (N_{T}) transmit antennas and multiple (N_{R}) receive antennas for data transmission. The antennas can relate to both base stations and mobile devices, in one example, allowing bi-directional communication between the devices on the wireless network. In addition, mobile devices and base stations can utilize a radio link control (RLC) layer to package data for transmission over then antennas. In particular, mobile devices and base stations can define service data units (SDU) representing logical portions of data to transmit, which can be associated into one or more fixed or variable length sized protocol data units (PDU) for transmission over the antennas at the RLC layer.

In addition, the mobile devices and base stations can employ automatic repeat request (ARQ) communication schemes that allow PDUs to be retransmitted if not received correctly to compensate for error in over-the-air communications. Moreover, with variable length PDUs, ARQ rounds can result in re-segmentation of a PDU to include more or less SDU data than the previous round. Thus, retransmissions can appear differently than original transmissions. However, wireless communication data can significantly lose value as it becomes stale due to real-time nature of the technology. Thus, at some point during retransmission, it can be helpful to notify a receiver of communication to discard stale data, and SDUs can be associated with timers to indicate such stale status. Other technologies have proposed systems that create a separate communication medium or channel to communicate this data between devices.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating data discard in wireless networks using in-band signaling resources. This mitigates need to create separate communications media or channels to transmit discarding instructions. In one example, a service data unit (SDU) length indicator can be provided within one or more related protocol data units (PDU) transmitted to a disparate device to indicate an ending position for the SDU. Additionally, the length indicator can be modified to specify when a transmitted SDU has been discarded. In this regard, the receiving device can discard the SDU and move on processing subsequent SDUs.

According to related aspects, a method for discarding stale SDUs in wireless communications networks is provided. The method can comprise receiving a stale status for a first SDU following transmission of a portion of, the first SDU in a first PDU. The method can further include packing a subset of the portion of the first SDU in a retransmit PDU and transmitting the retransmit PDU to one or more devices.

Another aspect relates to a wireless communications apparatus. The wireless communications apparatus can include at least one processor configured to determine a stale status for a SDU received at a radio link control (RLC) layer. The at least one processor is further configured to create a retransmit PDU comprising a portion of the SDU and/or a length indicator based at least in part on the stale status and transmit the retransmit PDU to one or more devices. The wireless communications apparatus can also include a memory coupled to the at least one processor.

Yet another aspect relates to a wireless communications apparatus that discards stale data at a RLC layer in wireless communications networks. The wireless communications apparatus can comprise means for receiving a stale status for a SDU. The wireless communications apparatus can additionally include means for packaging a retransmit PDU with an in-band stale data indicator based at least in part on the stale status of the SDU and means for transmitting the retransmit PDU to one or more devices.

Still another aspect relates to a computer program product, which can have a computer-readable medium including code for causing at least one computer to receive a stale status for a SDU. The computer-readable medium can also comprise code for causing the at least one computer to package a retransmit PDU with a length indicator based at least in part on the stale status of the SDU. Moreover, the computer-readable medium can comprise code for causing the at least one computer to transmit the retransmit PDU to one or more devices.

According to a further aspect, a method for discarding data at a RLC layer in wireless communications networks is presented. The method can include receiving a retransmit PDU from one or more transmitters. The method can additionally include identifying a special length indicator in the PDU specifying discard of a previously partially received SDU and discarding the previously partially received SDU.

Another aspect relates to a wireless communications apparatus. The wireless communications apparatus can include at least one processor configured to receive a retransmit PDU from one or more transmitters and determine a special length indicator in the PDU related to a previously partially received SDU. The at least one processor can be further configured to discard the previously partially received SDU based at least in part on the special length indicator. The wireless communications apparatus can also include a memory coupled to the at least one processor.

Yet another aspect relates to a wireless communications apparatus for discarding SDUs in wireless communications networks. The wireless communications apparatus can comprise means for receiving a retransmitted PDU and means for detecting a special length indicator in the retransmitted PDU. The wireless communications apparatus can additionally include means for discarding a previously received portion of an SDU based at least in part on the special length indicator.

Still another aspect relates to a computer program product, which can have a computer-readable medium including code for causing at least one computer to receive a retransmit PDU from one or more transmitters. The computer-readable medium can also comprise code for causing the at least one computer to identify a special length indicator in the PDU specifying discard of a previously partially received SDU. Moreover, the computer-readable medium can comprise code for causing the at least one computer to discard the previously partially received SDU.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment.

FIG. 3 is an illustration of an example wireless communications system that effectuates in-band indication of stale service data units (SDU).

FIG. 4 is an illustration of an example configuration for transmitting and retransmitting protocol data units (PDU).

FIG. 5 is an illustration of an example methodology that facilitates retransmitting a PDU comprising a stale SDU indicator.

FIG. 6 is an illustration of an example methodology that facilitates discarding one or more stale SDUs.

FIG. 7 is an illustration of an example mobile device that facilitates in-band indication of stale SDUs.

FIG. 8 is an illustration of an example system that facilitates discarding stale SDUs upon receiving notification in a PDU.

FIG. 9 is an illustration of an example wireless network environment that can be employed in conjunction with the various systems and methods described herein.

FIG. 10 is an illustration of an example system that transmits in-band stale SDU indicators.

FIG. 11 is an illustration of an example system that discards stale SDUs according to in-band stale SDU indicators.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

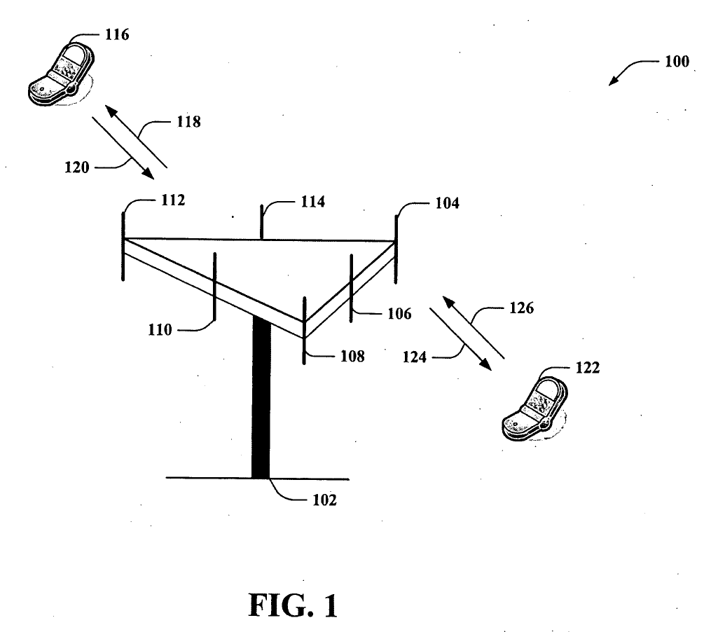

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology as depicted.

According to an example, system 100 can be a multiple-input multiple-output (MIMO) communication system. Further, system 100 can utilize substantially any type of duplexing technique to divide communication channels (e.g. forward link, reverse link, . . . ) such as FDD, TDD, and the like. Moreover, the base station 102 and mobile devices 116 and 122 can communicate on a number of logical communication layers over a physical layer. The layers can include a radio link control (RLC) layer that can transform one or more service data units (SDU) into one or more protocol data units (PDU) transmitted on a protocol level. For example, the SDU size can differ from the PDU size such that one or more SDUs can be concatenated and transmitted in a single PDU; likewise, a portion of an SDU can be segmented and transmitted in a plurality of PDUs. Additionally, a PDU can comprise a number of whole SDUs concatenated with an SDU segment. Moreover, the length of a given SDU and/or PDU can vary at substantially any point so that an indicator is desired to show a length or end position of each SDU in a PDU. This can be in a header of the PDU and/or terminate each SDU, for example.

In an example, such a length indicator can be provided in the PDU so that a receiver of the PDU can coherently separate the SDUs upon receipt. Thus, in one example, the mobile devices 116 and/or 122 can transmit RLC layer data to the base station 102 comprising a variable length PDU that includes one or more portions of one or more SDUs along with length indicators to show where the SDUs terminate or vice versa. In addition, the base station 102 and mobile devices 116 and/or 122 can communicate using an automatic repeat request (ARQ) scheme to account for PDUs not accurately received. To this end, the receiver can transmit feedback data regarding each PDU back to the transmitter indicating acknowledgement (ACK) or negative-acknowledgement (NAK). If NAK is received, the transmitter can retransmit the PDU. However, with variable length PDUs, the PDU can be re-segmented during an ARQ retransmission depending on available bandwidth; thus, the length indicator can help determine data being transmitted at each retransmission.

However, as mentioned, data can become stale in communications between the base station 102 and mobile devices 116 and/or 122 due to the real-time nature thereof. Accordingly, the length indicator can be extended or modified to provide an in-band indication of stale data that the receiver can discard. Moreover, the SDU data can be associated with a timer to indicate when the data becomes stale. For example, the mobile device 116 can transmit a PDU comprising an SDU and a partial subsequent SDU to the base station 102. The base station 102 can receive the PDU in error and can transmit a NAK to the mobile device 116. Subsequently, the stale timer for the first SDU can run, and the mobile device 116 can repack the PDU to include a special length indicator indicating to discard the first SDU along with the remaining subsequent SDU or portion thereof decreasing the payload of the retransmitted PDU. In another example, the PDU can be repacked with a portion of the partial subsequent SDU and other data (such as an additional portion of the partial subsequent SDU or one or more other SDUs) that fits since the first SDU is discarded. The mobile device 116 can transmit the PDU to the base station 102, and the base station 102, assuming it properly received the PDU this time, can determine the first SDU as discarded, by evaluating the special length indicator, and continue processing the subsequent SDU(s). It is to be appreciated that such in-band stale SDU discard notification can be utilized, additionally or alternatively, in communications from base station 102 to mobile devices 116 and/or 122. Thus, in-band indication of discarding SDUs is provided without the need for separate channels or mediums to indicate the discard.

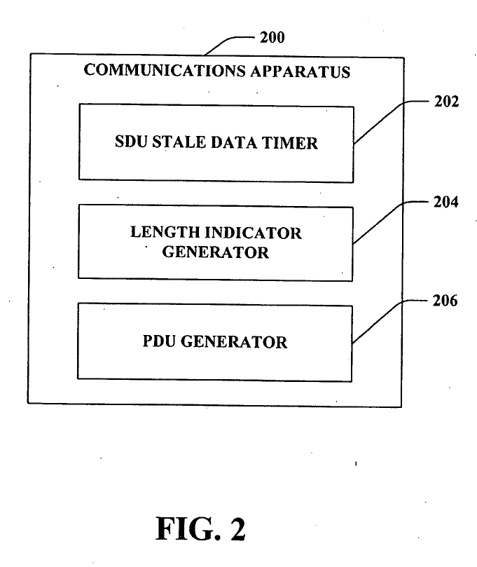

Turning to FIG. 2, illustrated is a communications apparatus 200 for employment within a wireless communications environment. The communications apparatus 200 can be a base station or a portion thereof, a mobile device or a portion thereof, or substantially any communications apparatus that receives data transmitted in a wireless communications environment. The communications apparatus 200 can include a module to determine if an SDU is stale, such as an SDU stale data timer 202 that can indicate when SDU data become stale, a length indicator generator 204 that can specify a length indicator for one or more SDUs for a PDU, and a PDU generator 206 that creates one or more PDUs comprising one or more SDUs, or portions thereof, along with one or more length indicators. Stale determination could also be based on queue size, such as a found in a drop-head queue or based other criteria.

In one example, the communications apparatus 200 can transmit data to one or more devices, base stations, and/or the like utilizing an RLC layer, along with additional layers. The transmitted data can include SDUs that indicate service data and can be transformed into one or more PDUs for transmission by a protocol layer. The SDU stale data timer 202 can associate the SDUs with a time at which the data is considered stale. This can be useful, for example, to ensure that old packets of a real time application are not transmitted, leaving over-the-air communication resources available for newer packets. If an SDU fails to be transmitted in one or more ARQ rounds, it can become irrelevant depending on the subsequent data transmitted, for example. In this regard, indicating that the transmission of this SDU has been aborted by the communication protocol can be desired. In a Radio Link Protocol, for example, the length indicator generator 204 can create a length indicator for each SDU that indicates the boundary of the SDU within the variable length PDUs. In this regard, the PDU generator 206 can create a PDU including one or more, or a potion of one or more, SDUs along with a specified length indicator. Thus, a device receiving the PDU can determine where SDUs start and end within the PDU or multiple PDUs (e.g., where the SDUs span one or more PDUs as described).

The communications apparatus 200, in one example, can transmit a PDU created as described above to one or more devices and can receive an ACK or NAK indicating respectively whether or not the protocol successfully received and/or decoded the PDU. If a NAK is received, the PDU can be re-segmented if the available PDU size has changed, and retransmitted. If, however, the SDU stale data timer 202 or other stale detection indicates an SDU that was partially transmitted in a previous PDU is stale before the retransmission occurs, length indicator generator 204 can create a special length indicator that indicates the SDU data received in the last PDU is to be discarded. Accordingly, the PDU generator can include the special length indicator in the retransmitted PDU, repack the PDU to include only non-stale SDU data and exclude the zero or more stale SDUs needing retransmission or transmission, and transmit the repacked PDU in an ARQ round. It is to be appreciated that where the PDU to be retransmitted begins with a new SDU, no special length indicator may be needed since the receiver likely has not received a partial SDU in the previous transmission; thus, the stale SDU can be purged without the need to indicate the discard to the receiver. Moreover, to this end, where multiple contiguous SDUs go stale before retransmission, only one special length indicator is needed if the first SDU was partially successfully transmitted in a previous PDU as the additional ones were not received in the first place. The initial PDU and the repacked PDU can bear the same RLC sequence number, in one example. Moreover, it is to be appreciated that the size of the initial and repacked RLC PDU can be different.

Upon receiving a retransmitted PDU from the communications apparatus 200, a device (not shown) can discard a previously partially received SDU based at least in part on the special length indicator transmitted in the retransmit PDU. The device can subsequently continue determining the SDUs transmitted in the retransmit repacked PDU. Thus, the device can discard the stale SDU via an in-band indicator without requiring separate data channels or mediums to transmit the discard information.

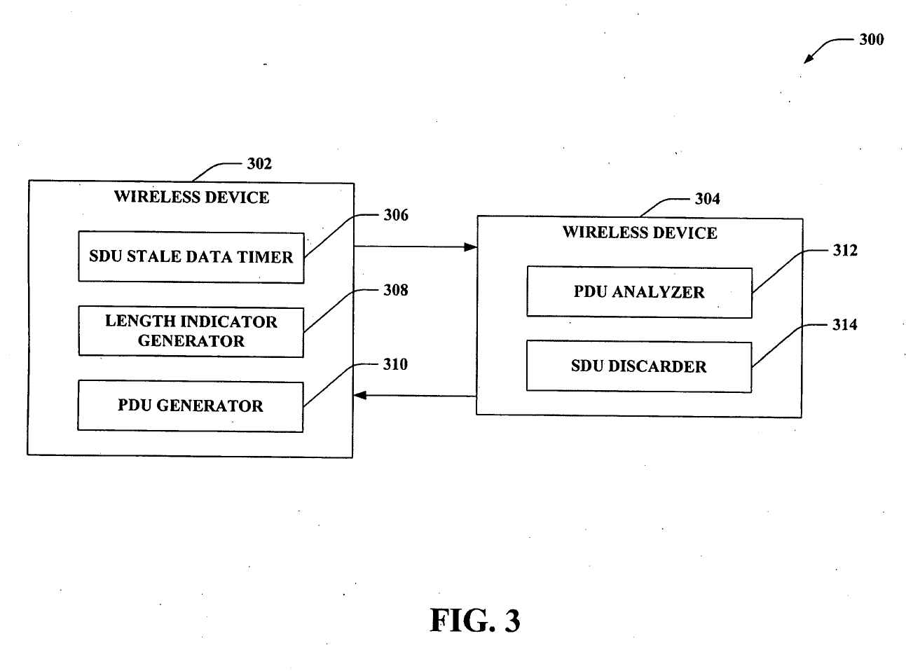

Now referring to FIG. 3, illustrated is a wireless communications system 300 that can communicate in-band indication to discard stale SDUs. The system 300 includes wireless devices 302 and 304 that communicate with each other (and/or any number of disparate wireless devices (not shown)). Each wireless device 302 and 304 can be a base station, mobile device, or portion thereof. In one example, wireless device 302 can transmit information to wireless device 304 over a forward link or downlink channel; further wireless device 302 can receive information from wireless device 304 over a reverse link or uplink channel. Moreover, system 300 can be a MIMO system, and the wireless devices 302 and 304 can communicate on an RLC layer that transforms service data into protocol data for transmission over a protocol layer. Also, the components and functionalities shown and described below in the wireless device 302 can be present in the wireless device 304 as well and vice versa, in one example; the configuration depicted excludes these components for ease of explanation.

Wireless device 302 includes a module to determine if an SDU is stale, such as an SDU stale data timer 306 (e.g., due to the real-time communications of the wireless communications system 300), a length indicator generator 308 that can provide a length indicator for one or more SDUs, and a PDU generator that can pack or repack PDUs with SDU data and respective length indicators. It is to be appreciated that one or more SDUs, or portions thereof, can be packed in a PDU. In an example, the length indicator for an SDU can point to the end of the SDU within the PDU to terminate the SDU such that a PDU comprising only a portion of an SDU can be missing the length indicator, which is transmitted in a subsequent PDU when the last portion of the SDU is transmitted. In another example, the length indicator can be a special “escape-sequence” located at the boundaries of SDUs within the PDU.

Wireless device 304 can include a PDU analyzer 312 that can determine positions of one or more (or a portion of) SDUs within a PDU for subsequent decoding and an SDU discarder 314 that can discard stale SDU data as specified by an in-band indicator. The wireless devices 302 and 304 can additionally communicate using an automatic retransmission scheme, such as ARQ, that provides redundancy to facilitate increase reliability in communication. In an example, the wireless device 302 can transmit variable length PDUs to the wireless device 304 comprising one or more full or partial SDUs as well as length indicators that terminate given SDUs, if applicable.

In one example, the wireless device 302 can create SDUs related to service data to transmit to wireless device 304. The SDU stale data timer 306 can additionally set a timer for the SDUs to indicate when the SDUs are stale as described. Stale determination can also be based on queue size, such as a found in a drop-head queue, or based on additional/alternative criteria, in one example. The length indicator generator 308 can create a length indicator to terminate the SDU, and the PDU generator 310 can create a variable length PDU comprising one or more SDUs or portions thereof, along with the length indicators where the SDU terminates within the PDU. Subsequently, the wireless device 302 can transmit the PDU to wireless device 304. The PDU analyzer 312 can evaluate the PDU to determine SDU positions based at least in part on the terminators, and can await subsequent PDUs where the last SDU is not terminated, for example. It is to be appreciated that the length indicators can alternatively be in a header of the PDU to indicate the SDU lengths.

According to an example, the wireless device 304 can receive a first PDU ending with a partial (e.g., non-terminated) SDU; to indicate successful receipt, the wireless device 304 can transmit an ACK to the wireless device 302 in response. The PDU generator 310 can then generate a subsequent PDU comprising the remainder of the previously non-terminated SDU along with a length indicator from the length indicator generator 308 specifying the end position of the partial SDU. It is to be appreciated that the SDU stale data timer 306 can have been started at transmission of the previous PDU having the first portion of the partial SDU, at initial receipt of the SDU in this protocol or in this device, and/or the like. The wireless device 302 can transmit the subsequent PDU to the wireless device 304, which can receive the PDU with error, for example, and indicate such by transmitting a NAK to the wireless device 302. Thus, the wireless device, following the ARQ scheme, can prepare a PDU for retransmission.

In one example, the SDU stale data timer 306 can indicate the SDU is stale before retransmitting, and the PDU generator 310 can repack the PDU with a special length indicator to specify discard of the partial SDU data along with subsequent SDUs (and related length indicators as applicable) and/or a partial SDU that fit within the allotted PDU size. The PDU can be transmitted to the wireless device 304, which if successfully received, can utilize the PDU analyzer 312 to evaluate the PDU. The PDU analyzer 312 can receive the special length indicator in the PDU convey this to the SDU discarder 314. The SDU discarder 314 can discard the SDU partially received in the previous PDU, and the PDU analyzer 314 can determine and evaluate subsequent SDUs or portions thereof transmitted in the PDU.

As mentioned above, it is to be appreciated that if the transmitted PDU comprises more than one terminated SDU and the PDU requires retransmission upon which the SDU timer for the more than one SDU indicates stale data, only one special length indicator is generated by the length indicator generator 308 and placed in the PDU by the PDU generator 310. This can be so since the wireless device 304 never received more than a partial SDU in the first successfully received transmission, and thus is not aware of the subsequently transmitted SDUs that were received in error and subsequently became stale. However, some applications can allow the receiving protocol to know how many SDUs were discarded. For example, a number of special length indicators equal to the number of SDUs discarded can be included. Another option can be to list a number of discarded SDUs within the special length indicator.

In another example, where SDU data becomes stale before transmission, the wireless devices 302 and 304 can allow higher communication layers to handle the discard. For example, upon retransmitting where data becomes stale beforehand, the PDU generator 310 can truncate some or all of the remaining bytes of the SDU or by replacing them with one or more random bytes in the retransmission PDU, along with a regular length indicator from length indicator generator 308 to specify the end of the truncated SDU. With this method, the receiving protocol does not necessarily identify the truncated SDU as a discarded SDU and can pass it to the upper layer for further processing. This method relies on upper layer to discard the truncated SDU based on other means, such as a TCP/IP checksum and/or the like. The PDU generator 310 can fill the rest of the PDU with subsequent SDUs or portions thereof and transmit the PDU to the wireless device 304. Upon receiving the PDU, the PDU analyzer 312 can determine the SDUs based on the length indicators, and a higher-level application can subsequently utilize the SDUs. The application (not shown) can determine the SDU to discard based on the truncation implemented by the PDU generator 310, in one example. Similarly, a plurality of SDUs having stale timers expire before retransmission can be truncated and transmitted in this regard leaving the discarding to the higher-level application.

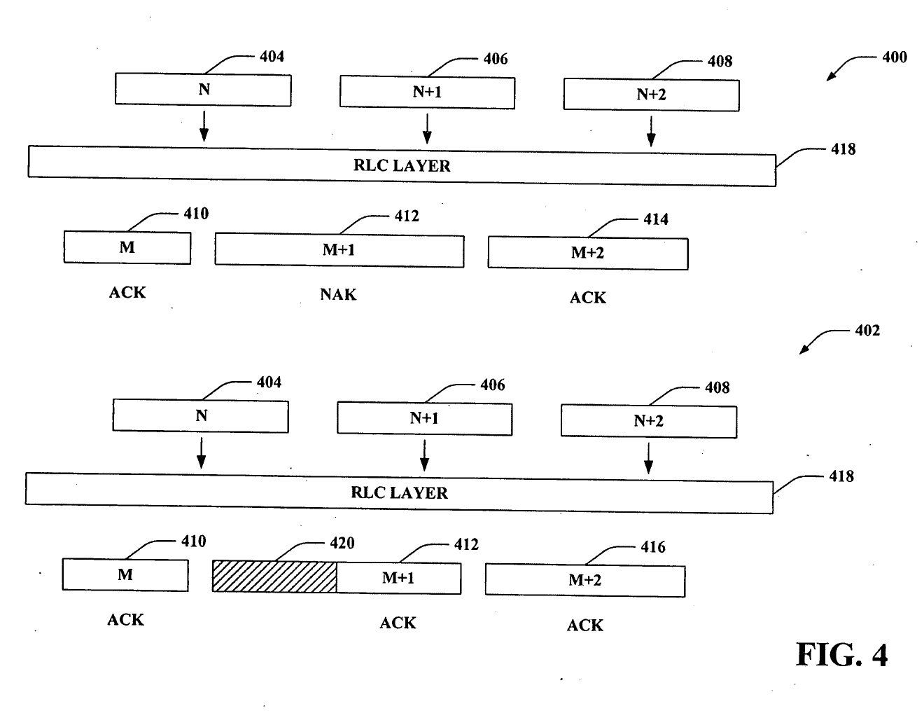

Turning now to FIG. 4, illustrated are an example transmission attempt 400 and retransmission attempt 402 of SDU data as one or more PDUs. A plurality of SDUs 404, 406, and 408 are provided that are packed into one or more PDUs 410, 412/420, 414, and 416 by an RLC layer 418. In transmission 402, the N SDU 404 can be partially packed into the M PDU 410. The M PDU 410 can be transmitted to a device, which returns an ACK indicating successful receipt of the M PDU 410. Subsequently, the M+1 PDU 412, which is packed with the remaining N SDU 404 and partial N+1 SDU 406 as well as PDU 414 including portions of SDU 406 and 408, can be transmitted to the device. However, upon sending the M+1 PDU 412 and M+2 PDU 414, the device can have returned a NAK, indicating failure in receiving the M+1 PDU 412 and ACK indicating success in receiving the M+2 PDU 414. Using ARQ, the M+1 PDU 412 can be repacked and retransmitted, which is shown at 402.

As described previously, the SDUs can be associated with a stale data timer to ensure time is not spent transmitting worthless data (e.g., old data in real-time configurations). In this retransmission 402, the SDU stale timer for the N SDU 404 can have expired indicating the N SDU 404 is stale after initial transmission. Thus, before retransmitting the M+1 PDU 412, a special length indicator can be placed in the M+1 PDU 412 indicating to discard the previous outstanding SDU, which is the N SDU 404. The M+1 PDU 412 can be repacked without data in the portion 420, aside from the special length indicator if not in the header, where the partial remaining N SDU 202 data would be. This reduces the payload of the retransmission and expedites delivery of non-stale data. In another example, the partial N+1 SDU 406 can be packed into the portion 420 and additional data or SDUs can fill the remaining space of the PDU 412. Subsequently, the PDU 412/420 can be transmitted to the device, and the device can read the special length indicator and discard the portion of the PDU M 410 carrying the SDU N 404 data as indicated. Additionally, the device can determine additional SDU locations in the retransmitted M+1 PDU 412/420.

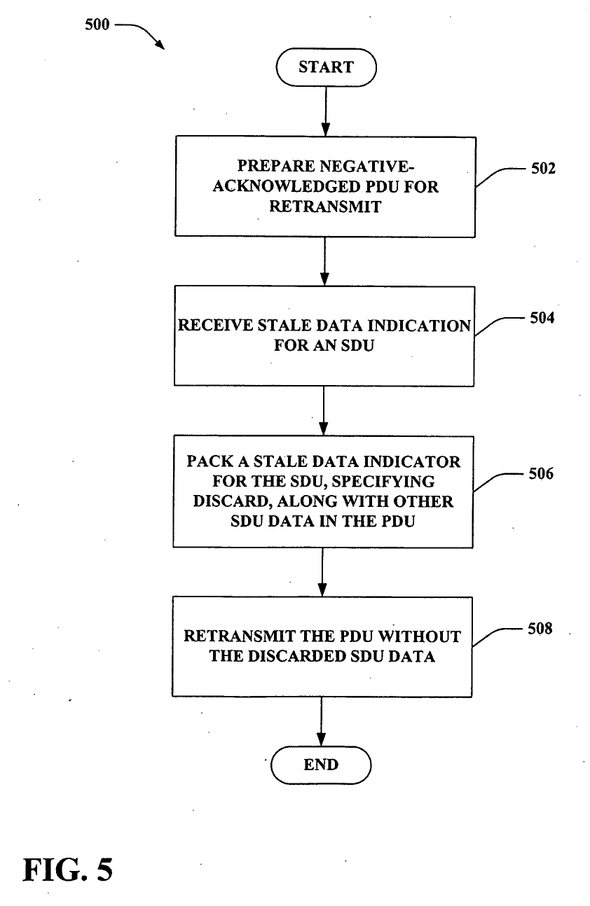

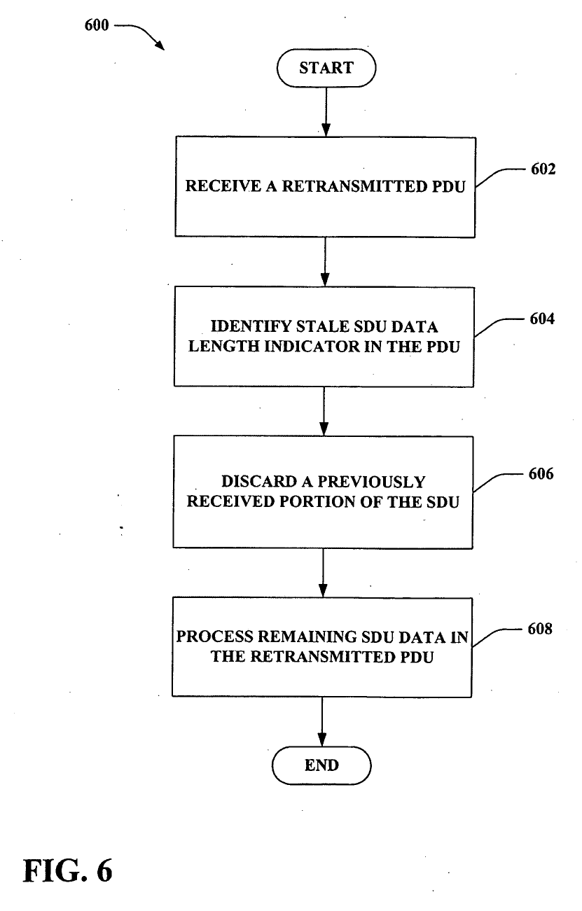

Referring to FIGS. 5-6, methodologies relating to discarding data at an ARQ protocol layer such as Radio Link Protocol are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 5, a methodology 500 that facilitates in-band indication of stale SDUs is displayed. At 502, a NAK PDU can be prepared for retransmit. In one example, the PDU can have been transmitted comprising a partial SDU, where the other portion of the SDU has been transmitted and successfully received. For instance, the PDU can have been received in error, and a NAK can have been received. In an ARQ scheme, NAK data units can be retransmitted. At 504, a stale data indication is received for an SDU in the PDU. For instance, this can be received from a timer initialized upon receiving the SDU and/or other stale data indicators as described herein. As mentioned, data in wireless networks can become stale due to the real-time nature of the communication and/or the semantics of the application, etc.

At 506, a stale data indicator, specifying discard, for the SDU can be packed into the retransmit PDU along with one or more other SDUs. In one example, the stale data indicator can be a special length indicator that specifies SDU discard. In this regard, the SDU data need not be retransmitted reducing the payload of the retransmit PDU. In another example, the stale data indicator can include truncating the SDU in the PDU allowing higher-layer applications to handle the discard and using a regular length indicator. Moreover, in an example, the NAK PDU can have previously attempted to transmit additional SDU data that is not yet stale; this data can be packed in the retransmit PDU along with the stale data indicator as well. At 508, the PDU can be retransmitted without the discarded SDU data. A receiver of the PDU can subsequently discard the previously transmitted portion of the SDU.

Turning to FIG. 6, illustrated is a methodology 600 that facilitates discarding one or more previously received SDUs in accordance with in-band notification received in a retransmitted PDU. At 602, a retransmitted PDU is received. For example, this can be received in a round of ARQ in response to previous NAK of a PDU. The previous NAK PDU can comprise a remaining portion of an SDU as well as one or more additional SDUs or portions thereof. At 604, stale SDU data can be identified in the PDU by a special length indicator. In addition, the PDU can comprise the one or more additional SDUs previously transmitted so long as the one or more SDUs are not stale. At 606, a previously received portion of the SDU can be discarded; this can be an initial portion related to the previously mentioned remaining portion transmitted in the NAK PDU. At 608, the remaining SDU data in the retransmitted PDU can be processed; this can include, for example, the one or more additional previously transmitted SDUs that are not yet stale.

It will be appreciated that, in accordance with one or more aspects described herein, inferences can be made regarding determining a stale state of SDU data as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

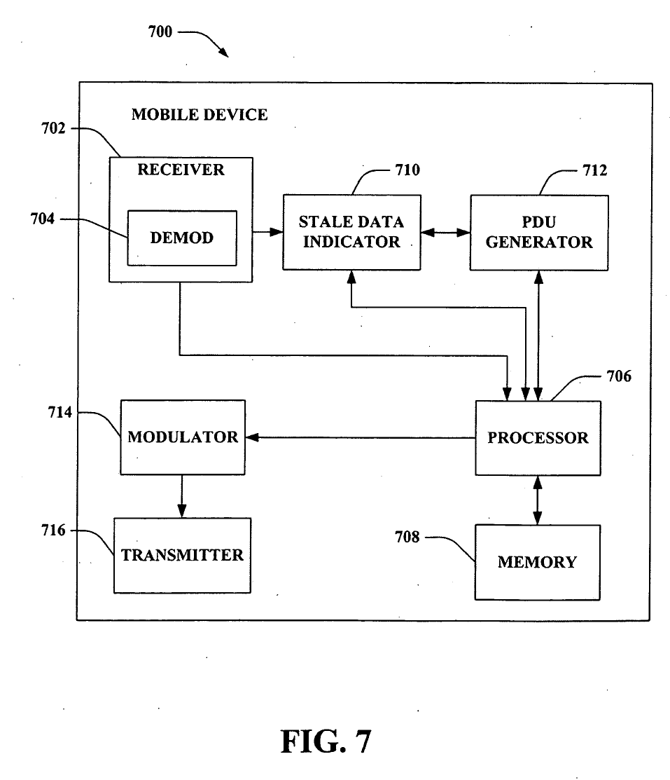

FIG. 7 is an illustration of a mobile device 700 that facilitates transmitting PDUs comprising in-band stale data indicators. Mobile device 700 comprises a receiver 702 that receives a signal from, for instance, a receive antenna (not shown), performs typical actions on (e.g. filters, amplifies, downconverts, etc.) the received signal, and digitizes the conditioned signal to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 716, a processor that controls one or more components of mobile device 700, and/or a processor that both analyzes information received by receiver 702, generates information for transmission by transmitter 716, and controls one or more components of mobile device 700.

Mobile device 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

Processor 706 and/or receiver 702 can further be operatively coupled to a stale data indicator 710 that can determine a stale state of one or more SDUs (received from an application, for example) and a PDU generator 712 that can create PDUs to transmit to disparate devices. In one example, the stale data indicator 710 can initialize a timer upon receiving SDUs to determine when the SDUs become stale. Upon becoming stale, if an SDU has yet to be successfully received (e.g., because of previous NAK transmissions), the stale data indicator 710 can generate an in-band notification of stale data, and thus not transmit the data to decrease payload of a retransmit PDU. The PDU generator 712 can generate a retransmit PDU comprising the in-band notification as well as previously transmitted NAK SDUs that are not yet stale. In one example, the in-band notification can be a special length indicator for an SDU specifying discard. Upon receipt, a device can discard previously received portions of the SDU. In another example, the in-band notification can include truncating the SDU data in the retransmitted PDU and including a regular length indicator at the end of the truncated data. This results in the SDU being conveyed to higher-layer applications at the receiver, which can determine the truncated data indicates the data is discarded. Mobile device 700 still further comprises a modulator 714 and transmitter 716 that respectively modulate and transmit signal to, for instance, a base station, another mobile device, etc. Although depicted as being separate from the processor 706, it is to be appreciated that the stale data indicator 710, PDU generator 712, demodulator 704, and/or modulator 714 can be part of the processor 706 or multiple processors (not shown).

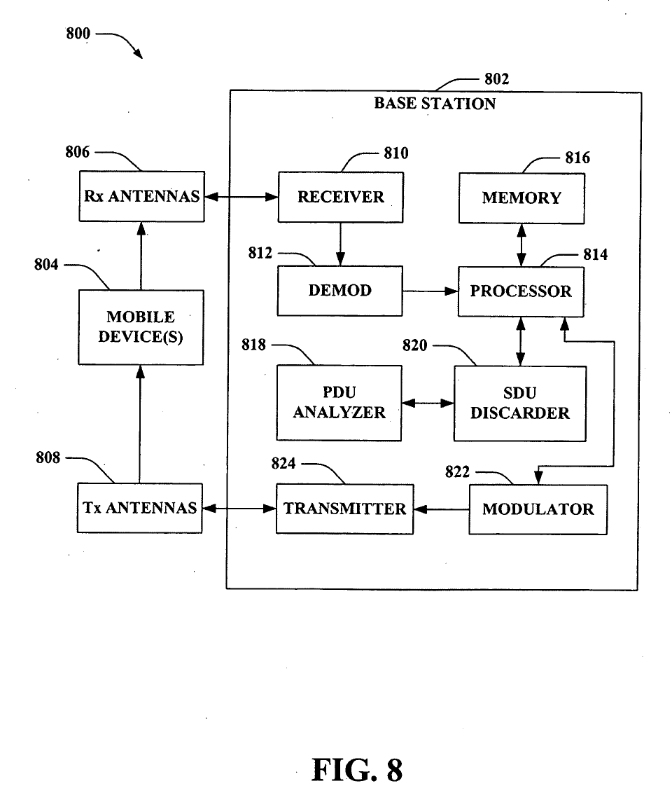

FIG. 8 is an illustration of a system 800 that facilitates receiving in-band indication to discard one or more previously partially received SDUs. The system 800 comprises a base station 802 (e.g., access point, . . . ) with a receiver 810 that receives signal(s) from one or more mobile devices 804 through a plurality of receive antennas 806, and a transmitter 824 that transmits to the one or more mobile devices 804 through a transmit antenna 808. Receiver 810 can receive information from receive antennas 806 and is operatively associated with a demodulator 812 that demodulates received information. Demodulated symbols are analyzed by a processor 814 that can be similar to the processor described above with regard to FIG. 7, and which is coupled to a memory 816 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein. Processor 814 is further coupled to a PDU analyzer 818 that determines SDU locations within one or more PDUs as well as an SDU discarder 820 that discards stale SDUs.

According to an example, the PDU analyzer 818 can receive and evaluate PDUs to determine SDU positions and/or contents. Additionally, the PDU analyzer 818 can detect in-band discard notifications in the PDUs. In one example, the discard notification for an SDU can be a special length indicator for the SDU. In another example, the discard notification can be intended for higher-layer applications as described. Where a special length indicator is received, the SDU discarder 820 can be utilized to discard previously received portions of the discarded SDU. The PDU analyzer 818 can continue to evaluate the remaining SDU data. Furthermore, although depicted as being separate from the processor 814, it is to be appreciated that the PDU analyzer 818, SDU discarder 820, demodulator 812, and/or modulator 822 can be part of the processor 814 or multiple processors (not shown).

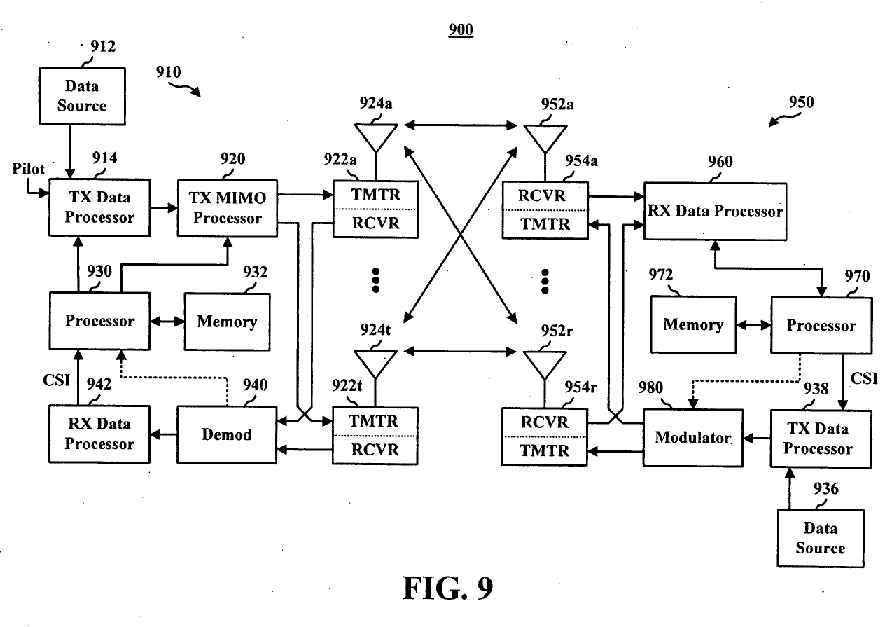

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-3 and 7-8), configurations (FIG. 4), and/or methods (FIGS. 5-6) described herein to facilitate wireless communication there between.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which preceding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g. control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

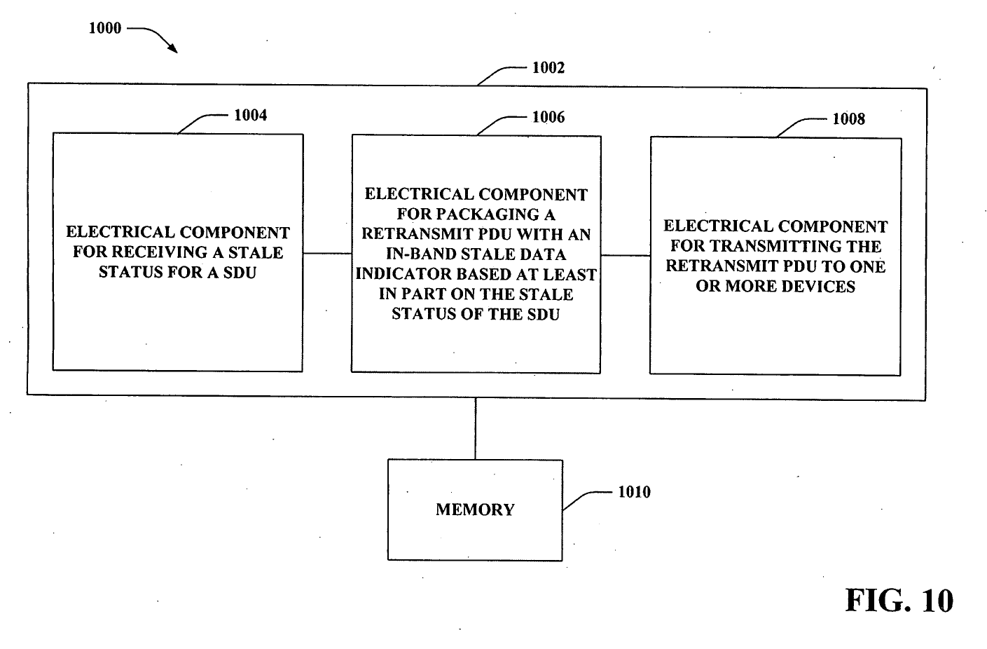

With reference to FIG. 10, illustrated is a system 1000 that retransmits PDUs comprising in-band SDU discard indicators. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include an electrical component for receiving a stale status for an SDU 1004. For example, the stale data status can be received from a timer initialized upon receipt of the SDU. Further, logical grouping 1002 can comprise an electrical component for packaging a retransmit PDU with an in-band stale data indicator based at least in part on the stale status of the SDU 1006. For example, as described, a NAK can be received for the PDU after a previous transmission attempt; however, between the previous transmission and the retransmission, one or more SDUs can become stale.

The in-band indicator can be a special length indicator, which is typically utilized for specifying length of an SDU, that specifies discard of the SDU. In this regard, the SDU need not be retransmitted if it is stale reducing payload and associated bandwidth waste of the retransmitted PDU. In another example, as described, retransmitting stale data and the associated bandwidth can be avoided by having the transmitter protocol truncate the SDU being retransmitted, use a regular length indicator to indicate the end of the SDU, rely on higher-layer applications to determine discard of the data, and/or the like. Moreover, logical grouping 1002 can comprise and electrical component for transmitting the retransmitted PDU to one or more devices 1008. In one example, receiving devices can utilize the stale data indicator to discard one or more previously partially received SDUs. Additionally, system 1000 can include a memory 1010 that retains instructions for executing functions associated with electrical components 1004, 1006, and 1008. While shown as being external to memory 1010, it is to be understood that one or more of electrical components 1004, 1006, and 1008 can exist within memory 1010.

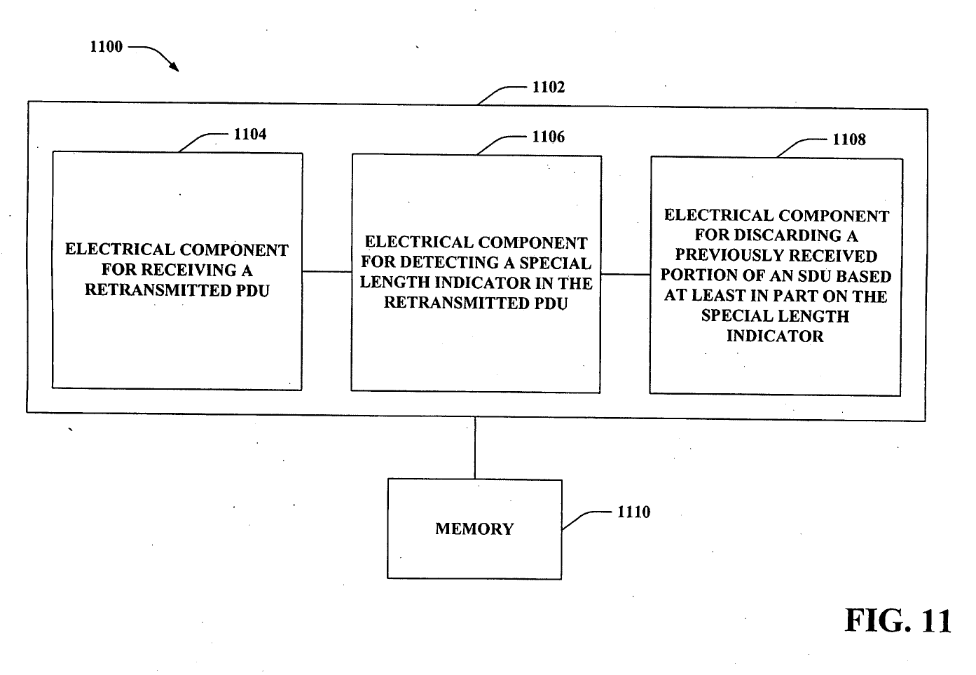

Turning to FIG. 11, illustrated is a system 1100 that discards SDUs according to a received in-band indicator in a wireless communications network. System 1100 can reside within a base station, mobile device, etc., for instance. As depicted, system 1100 includes functional blocks that can represent functions implemented by a processor, software, or combination thereof (e.g., firmware). System 1100 includes a logical grouping 1102 of electrical components that facilitate discarding stale SDUs. Logical grouping 1102 can include an electrical component for receiving a retransmitted PDU 1104. As described, the PDU can be retransmitted based on a received NAK related to a previous attempt to transmit the PDU. The PDU can be repacked before being retransmitted. Moreover, logical grouping 1102 can include an electrical component for detecting a special length indicator in the retransmitted PDU 1106. The special length indicator can specify to discard a previously partially transmitted SDU, as it has become stale. Furthermore, logical grouping 1102 can include an electrical component for discarding a previously received portion of an SDU based at least on part on the special length indicator 1108. Thus, stale SDUs can be discarded using an in-band notification. Additionally, system 1100 can include a memory 1110 that retains instructions for executing functions associated with electrical components 1104, 1106, and 1108. While shown as being external to memory 1110, it is to be understood that electrical components 1104, 1106, and 1108 can exist within memory 1110.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for discarding stale service data units (SDU) in wireless communications networks, comprising:
receiving a stale status for a first SDU following transmission of a portion of the first SDU in a first protocol data unit (PDU);
packing a subset of the portion of the first SDU in a retransmit PDU; and
transmitting the retransmit PDU to one or more devices.

2. The method of claim 1, the subset of the first portion of the SDU is associated with a length indicator in the retransmit PDU related to the subset of the portion of the SDU.

3. The method of claim 2, the length indicator is a special length indicator that specifies the stale status of the first SDU.

4. The method of claim 1, further comprising transmitting a disparate portion of the first SDU in a previous PDU.

5. The method of claim 1, further comprising transmitting the portion of the first SDU along with a portion of a second SDU in the first PDU.

6. The method of claim 1, further comprising receiving an indication of error in receipt of the first PDU.

7. The method of claim 6, the retransmit PDU is packed in response to receiving the indication of error in receipt of the first PDU.

8. The method of claim 1, the first PDU and the retransmit PDU have a substantially similar protocol sequence number.

9. A wireless communications apparatus, comprising:
at least one processor configured to:
determine a stale status for a service data unit (SDU) received at a radio link control (RLC) layer;
create a retransmit protocol data unit (PDU) comprising a portion of the SDU and/or a length indicator based at least in part on the stale status; and
transmit the retransmit PDU to one or more devices; and
a memory coupled to the at least one processor.

10. The wireless communications apparatus of claim 9, the stale status for the SDU indicates the SDU is stale and the length indicator for the SDU specifies that the SDU is discarded.

11. The wireless communications apparatus of claim 9, the at least one processor further configured to receive a negative-acknowledgement for a previous PDU comprising a larger portion of the SDU than that of the retransmit PDU.

12. The wireless communications apparatus of claim 11, the retransmit PDU is created in response to the negative-acknowledgement.

13. The wireless communications apparatus of claim 11, the retransmit PDU further comprising a portion of a subsequent SDU transmitted in the previous PDU.

14. The wireless communications apparatus of claim 11, the previous PDU and the retransmit PDU have a substantially similar protocol sequence number.

15. The wireless communications apparatus of claim 9, the at least one processer further configured to initialize a stale SDU timer upon receiving the SDU for transmitting.

16. A wireless communications apparatus that discards stale data at a radio link control (RLC) layer in wireless communications networks, comprising:
means for receiving a stale status for a service data unit (SDU);
means for packaging a retransmit protocol data unit (PDU) with an in-band stale data indicator based at least in part on the stale status of the SDU; and
means for transmitting the retransmit PDU to one or more devices.

17. The wireless communications apparatus of claim 16, the stale data indicator is a special length indicator specifying discard of the SDU.

18. The wireless communications apparatus of claim 16, the stale data indicator includes truncated data of the SDU discarded by a higher-layer application.

19. The wireless communications apparatus of claim 16, further comprising means for transmitting a previous PDU comprising a portion of the SDU and a portion of a second SDU.

20. The wireless communications apparatus of claim 19, further comprising means for receiving a negative-acknowledgement for the previous PDU, the retransmit PDU is packaged based at least in part on the negative-acknowledgement.

21. The wireless communications apparatus of claim 19, the retransmit PDU has a smaller payload than the previous PDU as the portion of the SDU is left out of the retransmit PDU.

22. The wireless communications apparatus of claim 19, the portion of the second SDU is packaged with the length indicator in the retransmit PDU.

23. The wireless communications apparatus of claim 19, the previous PDU and retransmit PDU have a substantially similar protocol sequence number.

24. A computer program product, comprising:
a computer-readable medium comprising:
code for causing at least one computer to receive a stale status for a service data unit (SDU);
code for causing the at least one computer to package a retransmit protocol data unit (PDU) with a length indicator based at least in part on the stale status of the SDU; and
code for causing the at least one computer to transmit the retransmit PDU to one or more devices.

25. The computer program product of claim 24, the stale status of the SDU indicates stale and the length indicator is a special length indicator specifying discard of the SDU.

26. A method for discarding data at a radio link control (RLC) layer in wireless communications networks, comprising:
receiving a retransmit protocol data unit (PDU) from one or more transmitters;
identifying a special length indicator in the PDU specifying discard of a previously partially received service data unit (SDU); and
discarding the previously partially received SDU.

27. The method of claim 26, further comprising processing one or more SDUs remaining in the retransmit PDU.

28. The method of claim 26, further comprising indicating discard of the SDU and/or additional SDUs to an upper layer according to the special length indicator.

29. The method of claim 26, further comprising receiving a previous PDU in error, the previous PDU comprising a remaining portion of the previously partially received SDU.

30. The method of claim 28, further comprising transmitting a negative-acknowledgement indicator based at least on part on receiving the previous PDU in error.

31. The method of claim 30, the retransmit PDU is received based at least in part on transmitting the negative-acknowledgement.

32. A wireless communications apparatus, comprising:
at least one processor configured to:
receive a retransmit protocol data unit (PDU) from one or more transmitters;
determine a special length indicator in the PDU related to a previously partially received service data unit (SDU); and
discard the previously partially received SDU based at least in part on the special length indicator; and
a memory coupled to the at least one processor.

33. The wireless communications apparatus of claim 32, the at least one processor further configured to process one or more SDUs remaining in the retransmit PDU.

34. The wireless communications apparatus of claim 32, the at least one processor further configured indicate discard of the previously partially received SDU and/or additional SDUs to an upper layer according to the special length indicator.

35. The wireless communications apparatus of claim 32, the at least one processor further configured to receive a previous PDU in error, the previous PDU comprising a remaining portion of the previously partially received SDU.

36. The wireless communications apparatus of claim 35, the at least one processor further configured to transmit a negative-acknowledgement indicator based at least in part on receiving the previous PDU in error.

37. The wireless communications apparatus of claim 36, the retransmit PDU is received based at least in part on transmitting the negative-acknowledgement.

38. A wireless communications apparatus for discarding service data units (SDU) in wireless communications networks, comprising:
means for receiving a retransmitted protocol data unit (PDU);
means for detecting a special length indicator in the retransmitted PDU; and
means for discarding a previously received portion of an SDU based at least in part on the special length indicator.

39. The wireless communications apparatus of claim 38, further comprising means for determining one or more disparate SDUs in the PDU.

40. The wireless communications apparatus of claim 39, further comprising means for receiving a previous PDU comprising a portion of the previously received SDU and a portion of the one or more disparate SDUs.

41. The wireless communications apparatus of claim 40, further comprising means for transmitting a negative-acknowledgement with respect to the previous PDU, the retransmitted PDU is received in response to the negative-acknowledgement.

42. The wireless communications apparatus of claim 38, further comprising means for specifying discard of the previously received portion of the SDU and/or additional SDUs to an upper layer according to the special length indicator.

43. The wireless communications apparatus of claim 38, further comprising means for receiving the discarded previously received portion of the SDU in a previous PDU.

44. A computer program product, comprising:
a computer-readable medium comprising:
code for causing at least one computer to receive a retransmit protocol data unit (PDU) from one or more transmitters;
code for causing the at least one computer to identify a special length indicator in the PDU specifying discard of a previously partially received service data unit (SDU); and
code for causing the at least one computer to discard the previously partially received SDU.

45. The computer program product of claim 44, the computer-readable medium further comprising code for causing the at least one computer to process one or more SDUs remaining in the retransmit PDU.
